(19) United States
(12) Patent Application Publication
(10) Pub. No.: US 2026/0061450 A1
(43) Pub. Date: Mar. 5, 2026

(54) ALIGNMENT TOOL FOR END EFFECTOR ATTACHED TO ROBOTIC ARM

(71) Applicant: Canvas Construction, Inc., San Francisco, CA (US)

(72) Inventors: Miles Flannery, San Francisco, CA (US); John Patrick Magee, Orinda, CA (US); Paul Long, San Francisco, CA (US)

(73) Assignee: Canvas Construction, Inc., San Francisco, CA (US)

(21) Appl. No.: 19/134,933

(22) PCT Filed: Dec. 4, 2023
(86) PCT No.: PCT/US2023/082246

§ 371 Date: Jun. 2, 2025

Related U.S. Application Data
(60) Provisional application No. 63/386,169, filed on Dec. 5, 2022.

(51) Int. Cl. B05B 15/652; B05B 1/04; B05B 13/04; B05B 15/16

(52) U.S. Cl. CPC B05B 15/652; B05B 1/04; B05B 13/0431; B05B 15/16

(57) ABSTRACT

Misalignment in a spraying end effector relative to a distal end of a robotic arm can cause unintended deviations to a width of sprayed band of material and/or cause an untended offset of the sprayed band of material relative to the intended center line. To address misalignment, an alignment tool can be provided to ensure that a rotatable spray tip and a rotatable spray guard of the spraying end effector maintain a fixed alignment relative to the distal end of the robotic arm. Misalignment in the pitch and roll axis can be effectively reduced or minimized by the alignment tool, so that the resulting sprayed band of material can be consistent over many sprayed bands. Also, the sprayed bands can have an accurate or intended width without a significant offset from the intended center line.

### TECHNICAL FIELD

The present disclosure generally relates to robotic systems, and, more specifically, to alignment tools for an end effector (such as a spraying end effector) attached to a robotic arm.

### BACKGROUND

In construction, surface finishing, such as drywall finishing, is a labor intensive task that is often completed by skilled and experienced professionals. One part of drywall finishing is to apply a joint compound or material that can fill in some areas of the surface so that a smooth, flat finish can later be achieved by sanding. A professional may use a handheld spray gun to spray and apply a layer of joint compound onto the surface.

### BRIEF DESCRIPTION OF THE DRAWINGS

The various advantages and features of the present technology will become apparent by reference to specific implementations illustrated in the appended drawings. A person of ordinary skill in the art will understand that these drawings show only some examples of the present technology and would not limit the scope of the present technology to these examples. Furthermore, the skilled artisan will appreciate the principles of the present technology as described and explained with additional specificity and detail through the use of the accompanying drawings.

FIG. 1 is a block diagram illustrating components of an exemplary robotic system, according to some aspects of the disclosed technology.

FIG. 2 illustrates an exemplary spraying end effector spraying material in a fan, according to some aspects of the disclosed technology.

FIG. 3 illustrates an exemplary diagram of a seam sprayed with a band of material, according to some aspects of the disclosed technology.

FIG. 4 illustrates tip alignment issues with an exemplary spraying end effector, according to some aspects of the disclosed technology.

FIG. 5 is a perspective view of an exemplary alignment tool, according to some aspects of the disclosed technology.

FIG. 6 is an exploded view of an exemplary alignment tool, according to some aspects of the disclosed technology.

FIG. 7A illustrates an exemplary alignment tool being used with an exemplary spraying end effector, the exemplary alignment tool having a slider in a first position, according to some aspects of the disclosed technology.

FIG. 7B illustrates an exemplary alignment tool being used with an exemplary spraying end effector, the exemplary alignment tool having with a slider in a second position and a lever in a locked position, according to some aspects of the disclosed technology.

FIG. 7C illustrates the exemplary alignment tool of FIG. 7B in a second position and having the lever in a transitional position, according to some aspects of the disclosed technology.

FIG. 8 illustrates a lever of the alignment tool in an unlocked position, according to some aspects of the disclosed technology.

FIG. 9 illustrates a lever of the alignment tool in a locked position, according to some aspects of the disclosed technology.

FIG. 10 illustrates a lever of an alignment tool in an unlocked position, according to some aspects of the disclosed technology.

FIG. 11 illustrates a lever of the alignment tool in a transitional position, according to some aspects of the disclosed technology.

FIG. 12 illustrates a lever of an alignment tool in a locked position, according to some aspects of the disclosed technology.

FIG. 13 is a perspective view of an exemplary wrap-around attachment member, according to some aspects of the disclosed technology.

FIG. 14 is a perspective view of an exemplary slider having a handle, according to some aspects of the disclosed technology.

FIG. 15 is a perspective view of an alignment tool being used with an exemplary spraying end effector, depicting a spring plunger embedded in the slider, according to some aspects of the disclosed technology.

FIG. 16 is a cross section view of the alignment tool of FIG. 15, according to some aspects of the disclosed technology.

FIG. 17 is a perspective cut view of the alignment tool of FIG. 15, according to some aspects of the disclosed technology.

FIG. 18 depicts a side view of an exemplary alignment tool being used with an exemplary spraying end effector, the exemplary alignment tool having a slider in a first position, according to some aspects of the disclosed technology.

FIG. 19 depicts a perspective view of the exemplary alignment tool of FIG. 18 having the slider in the first position, according to some aspects of the disclosed technology.

FIG. 20 depicts a side view of the exemplary alignment tool of FIG. 18, the exemplary alignment tool having the slider in a second position, according to some aspects of the disclosed technology.

FIG. 21 depicts a perspective view of the exemplary alignment tool of FIG. 18 having the slider in the second position, according to some aspects of the disclosed technology.

FIG. 22 depicts a side view of the exemplary alignment tool of FIG. 18, the exemplary alignment tool having the slider in a third position, according to some aspects of the disclosed technology.

FIG. 23 depicts a perspective view of the exemplary alignment tool of FIG. 18 having the slider in the third position, according to some aspects of the disclosed technology.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form to avoid obscuring the concepts of the subject technology.

### Overview

Misalignment in a spraying end effector relative to a distal end of a robotic arm can cause unintended deviations to a width of sprayed band of material and/or cause an untended offset of the sprayed band of material relative to the intended center line. To address misalignment, an alignment tool can be provided to ensure that a rotatable spray tip and a rotatable spray guard of the spraying end effector maintain a fixed alignment relative to the distal end of the robotic arm. Misalignment in the pitch and roll axis can be effectively reduced or minimized by the alignment tool, so that the resulting sprayed band of material can be consistent over many sprayed bands. Also, the sprayed bands can have an accurate or intended width without a significant offset from the intended center line.

### Exemplary Robotic System, Such as a Robotic System Suitable for Surface Finishing

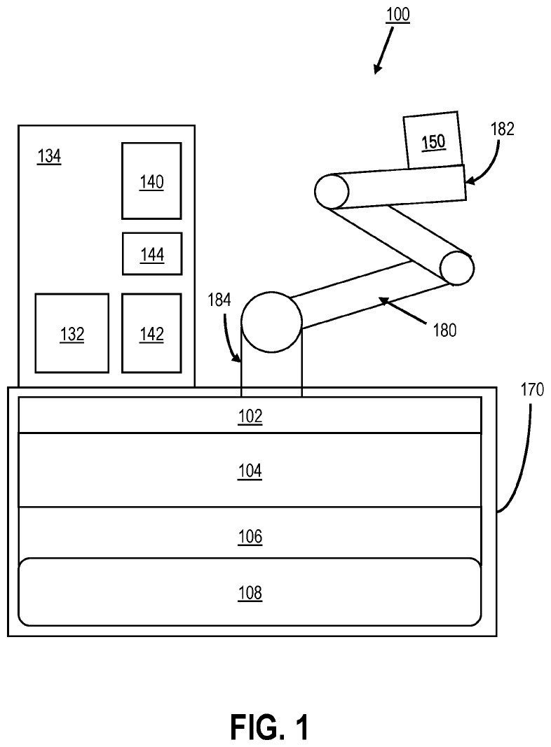

FIG. 1 is a block diagram illustrating components of an exemplary robotic system, according to some aspects of the disclosed technology. Robotic system 100 can be a surface finishing system.

Robotic system 100 may include a base unit 170, a robotic arm 180, and one or more end effectors 150. For simplicity, the passages may refer to an end effector 150. The base unit 170 may include platform 102 and a cart 106, with a lift 104 disposed between the platform 102 and cart 106. A base end 184 (end that is attached to platform 102) of the robotic arm 180 may be physically coupled to the base unit 170, e.g., at platform 102, or at cart 106. Cart 106 can be disposed at or near the ground and may be movable by wheels 108 or other mechanisms such as a belt with treads. The lift 104 can raise platform 102 up and down, if used. In some examples, lift 104 may include a scissor lift or other suitable height adjustment mechanisms that can raise and lower platform 102 relative to the cart 106.

Robotic system 100 may include one or more input interfaces that allow for various systems to couple with the robotic system 100. The one or more input interfaces may allow for resources provided by such systems to be provided to the robotic arm 180 and/or the end effector 150 coupled at a distal end 182 (end that has the end effector 150 affixed thereto) of the robotic arm 180. For example, a pneumatic source, a power source, a vacuum source, a paint source, a coating or joint compound source, or the like can be coupled to robotic system 100, at any suitable location of the robotic system 100.

In various embodiments, robotic arm 180 can comprise one or more suitable robotic arms or positioning systems, which can include pneumatic actuators, electric actuators, and the like. The robotic arm 180 can have any suitable number of degrees of freedom. Robotic arm 180 may include sensors to detect positioning of various parts of the robotic arm 180, and optionally objects or people in the vicinity of the robotic arm 180. In some cases, the robotic arm 180 may include a lifting mechanism or height adjustment mechanism, in combination with other positioning system(s) operable to adjust position of a distal end 182 of the robotic arm 180 in space.

In some cases, the robotic arm 180 may be replaced by or supplemented with other types of positioning system such as a gantry (XY) positioning system. A gantry positioning system may include a first end that is affixed to the base unit 170, and an attachment end. The gantry positioning system may have a first track for moving the attachment end in a first direction and a second track for moving the attachment end in a second direction perpendicular to the first direction. In some cases, the one or more end effectors 150 may be attached to the attachment end of the gantry positioning system, and the position of the one or more end effectors 150 may be adjusted using the gantry positioning system. In addition to the gantry positioning system, the robotic system 100 may include a fine movement component that connects the one or more end effectors 150 to the attachment end of the gantry positioning system. The fine movement component may adjust a position the one or more end effectors 150. The fine movement component may rotate the orientation of one or more end effectors 150 (e.g., to adjust a fan bias angle of a spraying end effector). The fine movement component can perform a flicking movement in some cases.

The robotic system 100 can further include a control system 134, which may include a perception system 140, sensors 144, and a movement system 142. In some cases, sensors 144 may be provided with robotic arm 180. In some cases, sensors 144 may be provided with the end effector 150. Control system 134 may include a user interface 132 (e.g., communicably coupled to control system 134 via wired or wireless means). Control system 134 may electronically trigger operations of the one or more end effectors 150.

Sensors may include one or more of: visible spectrum camera, radio detection and ranging (RADAR), light detection and ranging (LIDAR) system, sound navigation and ranging (SONAR) system, camera (e.g., infrared camera, thermal camera, stereo cameras, structured light camera, and the like), laser scanners, time of flight sensors, inertial measurement unit (IMU), a vision system, capacitive sensors, temperature sensors, impedance sensors, pressure sensors, audio sensors, humidity sensor, air flow sensors, proximity sensors, laser curtains, force and torque sensors, limit switches, rotameter, spring and piston flow meter, ultrasonic flow meter, turbine meter, paddlewheel meter, variable area meter, positive displacement, vortex meter, pitot tube or differential pressure meters, magnetic meters, conductivity sensor, and depth or thickness sensors, and the like.

Perception systems 140 may receive input from the sensors 144 and perceive the environment surrounding the robotic system 100. Perception systems 140 may determine location of seams of a wall assembly (or part of a building structure). Perception systems 140 may determine location of structural components of a wall assembly (or part of a building structure).

The movement system 142 may determine commands to actuate elements of the robotic system 100 to move one or more of: the robotic arm 180, lift 104, and wheels 108. Such commands may be generated for an electric motor, pneumatic actuators, piezoelectric actuator, and the like. In some cases, the movement system 142 may command lift 104 to control the height of lift 104. In some cases, the movement system 142 may command wheels 108 to control the position and heading of the base unit 170. In some cases, the movement system 142 may command the robotic arm 180 to move, change the orientation of, rotate, or otherwise configure the end effector 150 (e.g., relative to a wall, ceiling, or floor).

An end effector 150 can be coupled or affixed at the distal end 182 of the robotic arm 180. In some examples, the robotic system 100 can comprise modular and/or multi-use end effectors 150, which can be configured for various material application tasks, wall, ceiling and/or floor preparation, wall, ceiling and/or floor finishing, dry walling tasks, construction tasks, or other tasks. For example, as discussed herein, end effectors 150 can be configured for substrate planning, substrate hanging, applying coating or joint compound to hung substrate, sanding the coating, painting, and the like. Although various examples herein relate to surface finishing, further embodiments of the robotic system 100 can be configured for any suitable tasks, including other construction tasks, manufacturing tasks, gardening tasks, farming tasks, inspection tasks, compliance tasks, planning tasks, domestic tasks, and the like. Accordingly, the discussions herein related to dry walling and construction should not be construed to be limiting on the wide variety of tasks that the robotic system 100 can be configured for.

End effectors 150 can comprise various suitable devices, including a cutting device, hanging device, coating device, sanding device, painting device, vacuum device, a sprayer (or spraying device), fastening device, screwing device, fastener driver device, impact device, scraping device, vibrational device, tape application device, measuring device, material removal device, testing device, fan device, suction device, grinding device, heat application device, welding device, burning device, etching device, mixing device, sawing device, router or shaping device, tying device, bending device, riveting device, and the like. Other suitable devices can be part of an end effector 150 and can be selected based on any desired task that the end effector 150 may be used for. For various end effectors 150, proper alignment relative to the distal end 182 of robotic arm 180 may impact accuracy and/or precision of the end effector 150 in performing the task. Components of end effectors 150 may become misaligned in pitch, roll, and/or yaw directions.

### Exemplary Situations Where Accuracy and/or Precision of End Effector May Be Impacted by Misalignment

The robotic system 100 as illustrated in FIG. 1 can be used in a variety of situations, such as when to deposit material onto a surface with accuracy and/or precision. One example of such a situation is to accurately and selectively apply or deposit material in a region while avoiding depositing material in another region. Another situation is to selectively apply or deposit material with a certain thickness with accuracy. Robotic system 100 may be used to deposit material to selected structural components of a wall assembly or building structure. For instance, the robotic system 100 may be used when selectively applying touch-up paint to a gap on a surface, when selectively covering seams with joint compound, and/or when spraying material to a certain thickness while avoiding areas that are already at a thickness level. To better understand one of such situations, the following passages describe joints and how bands of material can be sprayed to cover joints.

Joints are formed by abutting edges of adjacent components. For example, abutting edges of adjacent boards of substrate form a joint. The terms “joint” and “seam” are used interchangeably in the present disclosure. A tapered joint (also known as a “factory” joint) is formed by abutting tapered edges of adjacent components. A tapered joint creates a valley in which coating material can be applied to create a level surface relative to a face of the substrate. A butt joint is formed by abutting flat edges of adjacent components. In contrast to tapered joints, butt joints lack a formal valley in which a coating material can lie to create a level surface. Creating the appearance of flatness can be easier for tapered joints than it is for butt joints because the valley in tapered joints can hide much of the coating material. In contrast, for butt joints, much of the material extends beyond the plane of the surface of the substrate. A mixed joint (also known as a bastard joint) is formed by abutting a tapered edge and a flat edge of adjacent components. Mixed joints have only a portion of the valley for the coating material.

During coating work, robotic system 100 of FIG. 1 can apply a layer of coating material to joints that may have a thickness that is greater than is manually applied by human workers to allow for a sanding system (e.g., a sanding end effector) to sand down the compound to a desired plane. For example, in some examples, manual joint compound application mud can be profiled to taper from high points. The robotic system 100 can apply a thicker layer than normal, enabling a sanding system to sand down high points to be level to the adjacent surfaces.

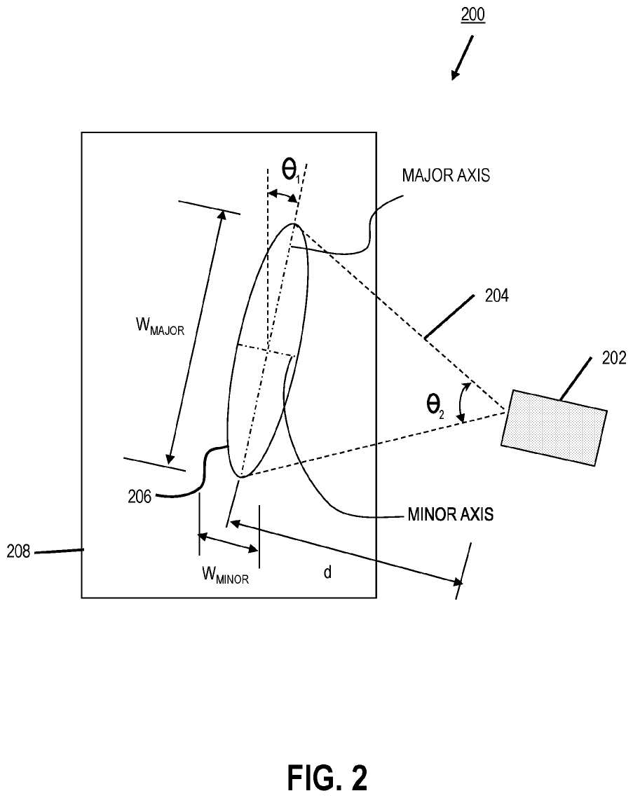

FIG. 2 illustrates an exemplary diagram 200 of a spraying end effector spraying material in a fan, according to some aspects of the disclosed technology. A spraying end effector 202 is located a distance, d, from a surface 208 while spraying material in a fan 204 that has a spread angle, θ₂, and produces a spray pattern 206. The spray pattern 206 can be elliptical in shape. The spray pattern 206 has a major axis and a minor axis. The major axis has a corresponding major width, W_{MAJOR}, measured along the major axis. The minor axis has a corresponding minor width, W_{MINOR}, measured along the minor axis. The spraying end effector 202 can be rotated about an axis that passes through a center of the orifice of a spray tip of the spraying end effector 202 and the center of the fan 204; such rotation about the axis biases the spray pattern 206 at a fan bias angle, θ₁. When the spraying end effector 202 is rotated at an angle of 0 or 360 degrees, the width of the material sprayed from the spraying end effector 202 is equal to the major width, W_{MAJOR}. When the sprayed at an angle between 0 and 360 degrees, the width of the material sprayed from the spraying end effector 202 is less than the major width, W_{MAJOR}.

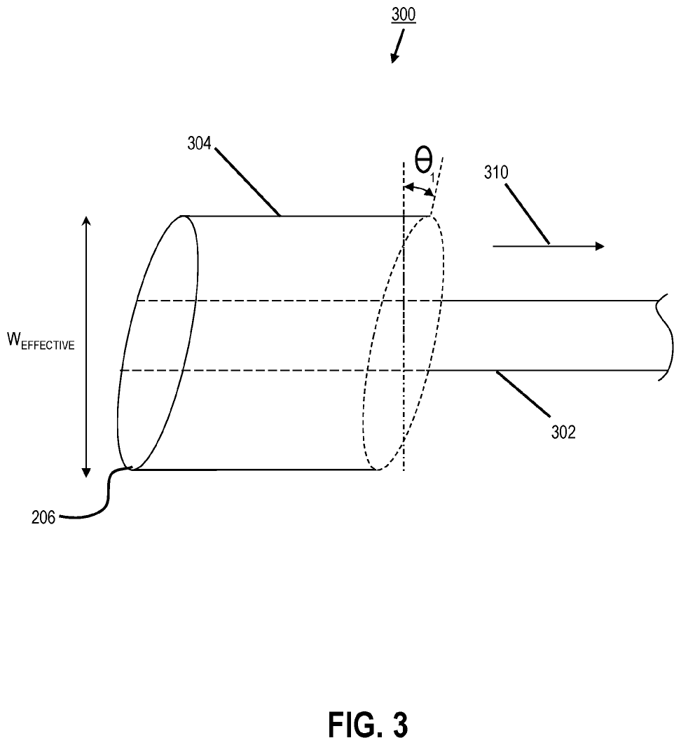

FIG. 3 illustrates an exemplary diagram 300 of a seam 302 sprayed with a band of material 304, according to some aspects of the disclosed technology. The band of material 304 is formed by the spraying end effector 202 of FIG. 2 when rotated at the fan bias angle, θ₁. The spraying end effector 202 moves in the direction indicated by arrow 310 while spraying the band of material 304.

Because the spraying end effector 202 is rotated, the spray pattern 206 is biased at the fan bias angle, θ₁ and the effective width, W_{EFFECTIVE}, of the spray pattern 206 is less than the major width, W_{MAJOR}. The thickness of the material deposited by the spraying end effector 202 varies based on, among other things, the speed at which the spraying end effector 202 moves in the direction of arrow 310 while spraying the material. For example, increasing the speed of the spraying end effector 202 reduces the thickness of the sprayed material and vice versa. A flow rate of the spraying end effector 202 can depend on the amount of pressure driving the material through the spraying end effector 202, material viscosity, a size of the orifice on the spray tip of spraying end effector 202, and an amount of wear around the orifice (e.g., more wear can increase the size of the orifice). Parameters of the sprayed material (e.g., effective width and thickness) are based on parameters of the spraying end effector 202 (e.g., distance to the sprayed surface, spread angle of the fan, rotation of the end effector). Thus, surface finishing systems of the present disclosure vary the parameters of the spraying end effector 202 to achieve desired or intended specifications of the sprayed material.

### Misalignment Issues of Spraying End Effectors and Their Impact Thereof

An end effector (e.g., an end effector 150 on distal end 182 or robotic arm 180 of FIG. 1) may be assumed to have a certain pose (e.g., zero degrees alignment in the pitch, roll, and yaw axis, and at the origin of a three-dimensional space). This assumed pose of the end effector may be considered the initial or proper alignment or position of the end effector.

In some cases, the pose of the end effector may be measured or calibrated (e.g., based on manual measurement(s), feedback information, and/or sensor measurement(s)). The alignment may not be at exactly zero degrees and position may not be at exactly the origin. This measured calibrated pose of the end effector may be considered the initial or proper alignment of the end effector.

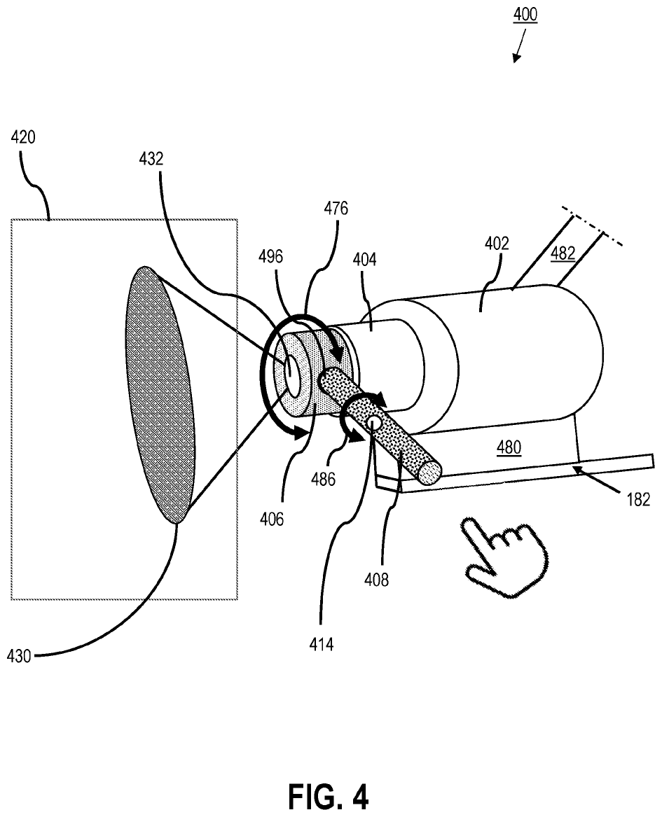

FIG. 4 illustrates tip alignment issues with an exemplary spraying end effector, according to some aspects of the disclosed technology. Diagram 400 shows a spraying end effector to spray a spray pattern 430 onto surface 420.

The spraying end effector can include a spray gun 402, and a manifold 480 (which is affixed to robotic arm 180 of FIG. 1). Manifold 480 may have (fluid) passages and ports to allow for various materials to be provided to and away from spray gun 402. A fluid supply hose 482 having material to be sprayed (e.g., mud) may be connected to a port of manifold 480. Manifold 480 may have other passages or boreholes. Spray gun 402 may be mounted or mated with ports of the manifold 480. The manifold 480 may be mounted to a distal end 182 of robotic arm 180 of FIG. 1).

The spraying end effector can include a spray guard 406 that can be fastened to the spray gun 402 with fastener 404. Fastener 404 may be a nut. The spray guard 406 can be fully (and easily) rotatable in the roll axis while the fastener 404 is firmly fastened to the spray gun 402. The movement in the roll axis is indicated by arrow 476. When the spray guard 406 is rotated, the fan bias angle changes. When fan bias angle changes, the effective width W_{EFFECTIVE} of the spray pattern 430 changes. Unintentional rotation or deviation from the initial or proper alignment or position of the spray guard 406 can cause unintentional changes to characteristics of a band of sprayed material, e.g., width.

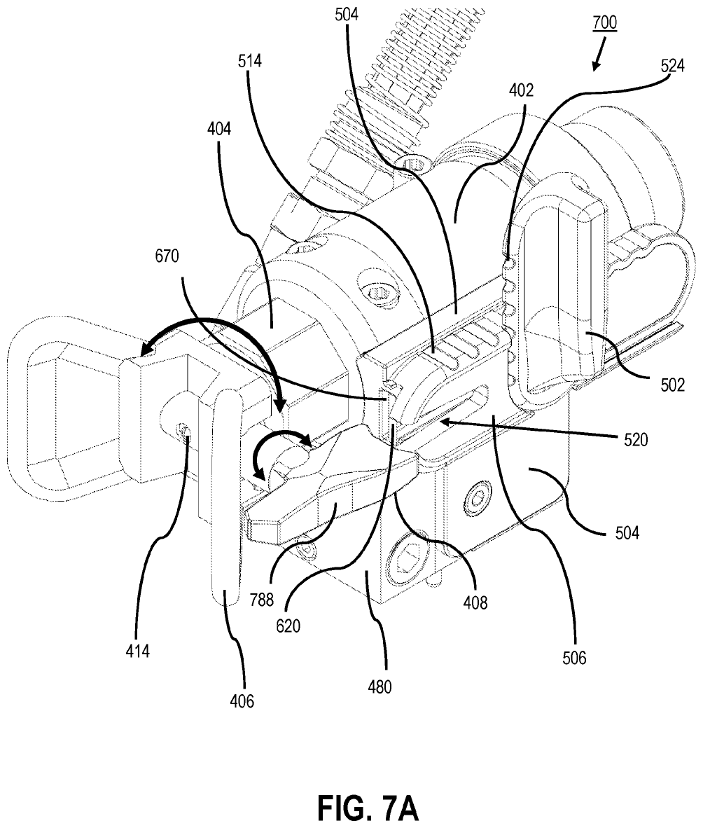

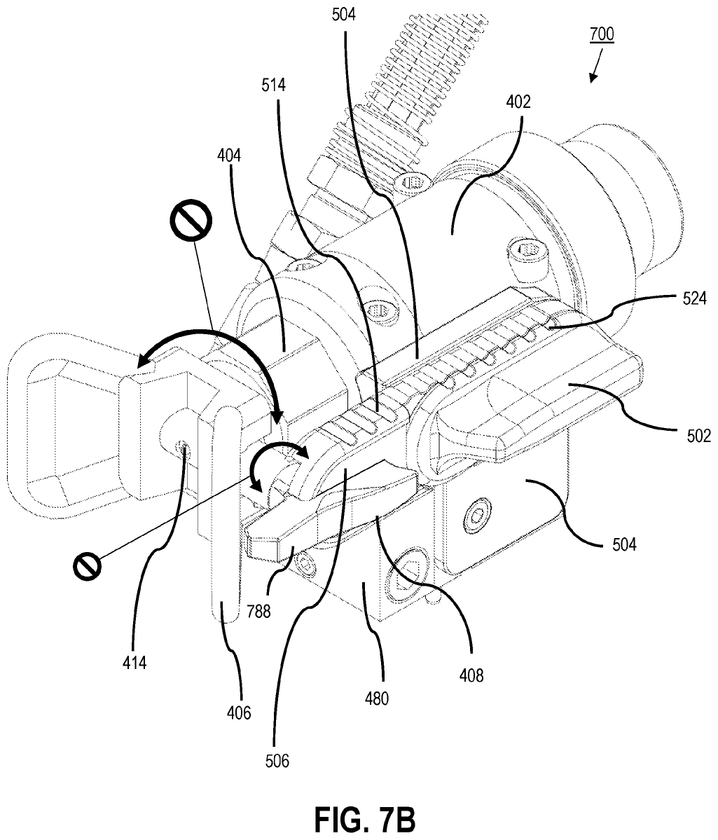

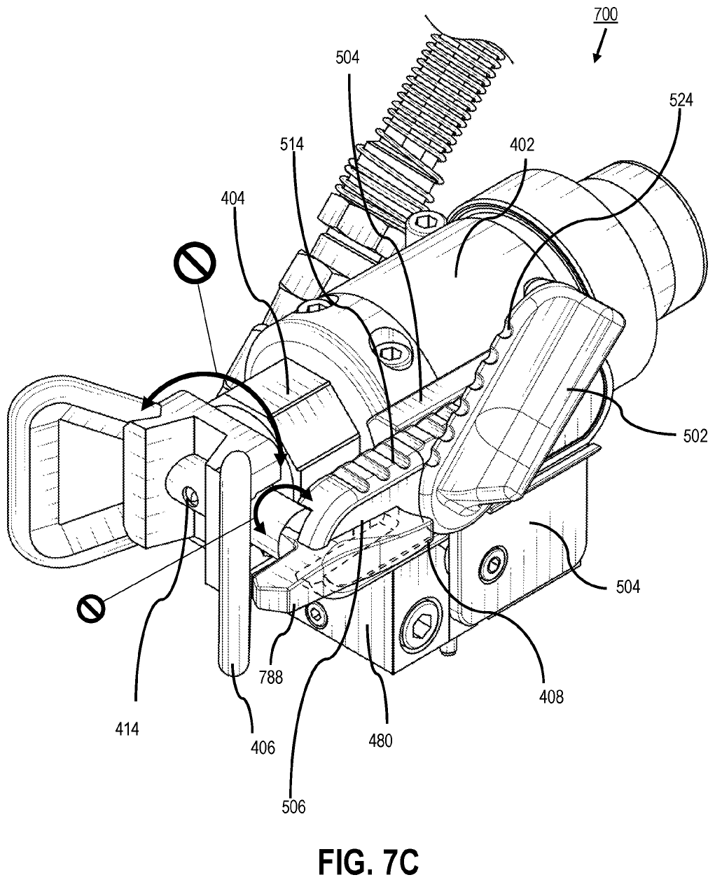

The spraying end effector also includes a spray tip 408 which can be inserted into a fitted opening 496 of the spray guard 406. The spray tip 408 can include an orifice 414, e.g., in a cylindrical portion of the spray tip 408, that allows the spray gun to provide material through the orifice 414 and outward towards the surface 420. The spray tip 408 has a cylindrical portion, which allows the spray tip 408 to be rotatable in the pitch axis within the spray guard. The movement in the pitch axis is indicated by arrow 486. The spray tip 408 can have an orifice 414 pointing away perpendicularly from a long axis of a cylindrical portion of the spray tip 408, the orifice is to release material (from spray gun 402) in a fan (e.g., according to FIGS. 2-3). The spray tip 408 can be inserted in opening 496 of spray guard 406 of the spraying end effector. The spray tip 408 may include a non-cylindrical (e.g., flat) portion that allows a user to hold, handle, or rotate the spray tip 408. The portion may be referred to as a handle (or grip) of the spray tip 408. The non-cylindrical portion may have one or more flat surfaces that a user may hold to rotate the spray tip 408. The non-cylindrical portion is not depicted in FIG. 4 but is at least partially depicted in other figures such as FIGS. 7A-C, and 15-23.

Spray guard 406 has spray opening (or area) 432. Spray guard 406 may have different shapes and designs. Spray guard 406 may be included with the spraying end effector to hold the spray tip 408. Spray guard 406 may include one or more physical structures that prevent users from touching, contacting, or getting too close to orifice 414 of the spray tip 408. Such physical structures may help to provide safer spraying at higher pressures. Spray guard 406 may include grips to allow users to handle spray guard 406 (e.g., for installing spray guard 406 onto the spraying end effector). Spray guard 406 can help to eliminate material build-up, dripping and spitting.

When spray tip 408 is rotated, the direction of the orifice 414 can change (rotating upwards or rotating downwards) in the pitch axis (indicated by arrow 486). When the direction of the orifice 414 changes, an offset occurs with the band of sprayed material formed with spray pattern 430. Unintentional rotation or deviation from the initial or proper alignment or position of the spray tip orifice 414 can cause unintentional offset from the intended center line of the band of sprayed material. While there may be mechanical features on the spray tip that may help to ensure a fixed alignment or direction of the orifice 414, those mechanical features may wear and tear over time (e.g., become loose), and their effectiveness to ensure alignment can degrade overtime.

When in use (e.g., ready to spray material), orifice 414 of spray tip may be rotated (e.g., using the handle) in the pitch axis such that orifice 414 may point forward. Orifice 414, when pointed in the forward direction, may be aligned with spray opening 432 of spray guard 406. The spray tip 408 may be in an engaged position. Material from spray gun 402 may travel through orifice 414 when orifice 414 is in the engaged position.

When not in use (e.g., not ready to spray material), orifice 414 may be rotated (e.g., using the handle) in the pitch axis by 90 degrees or so such that orifice 414 may point upwards or downwards. Orifice 414, when pointed in the upward or downward direction, may be at least partially shielded by spray guard 406. The spray tip 408 may be in a locked position. Material from spray gun 402 cannot travel through orifice 414 when orifice 414 is in the locked position.

Misalignment of an end effector (e.g., end effector 150 of FIG. 1) can impact the toolpath. Toolpath represents the path through space and time that the end effector follows to cause an effect or generate an output, e.g., spraying a band of material having certain parameters and characteristics such as a position of a center line, width of the band, length of the band, thicknesses of the band at various positions, etc. When the end effector is misaligned, it becomes more difficult for a robotic arm (e.g., robotic arm 180 of FIG. 1) to consistently produce outputs that have accurate and/or precise parameters and characteristics. Repeatability can be impacted when an effector becomes misaligned. In some cases, the output of the end effector may be sensed or detected by a perception system (e.g., perception system 140) to update or calibrate the perception system and/or a model of the end effector. If the output is impacted by uncorrelated and/or unexpected misalignment of the end effector, the calibration of the model of the end effector may be negatively impacted or adjusted incorrectly, which in turn may cause more inaccuracies in the output of the end effector.

For a spraying end effector, unintended changes to the parameters and/or characteristics of the sprayed material (e.g., the width and offset) can be undesirable, and can cause inconsistent and inaccurate spraying of materials on surfaces. Inaccurate spraying may lead to wasteful use of materials. If parameters of the band of spray materials are incorrect, the robotic system may take longer to sand down the material to reach a smooth flat surface. In some cases, misalignment can result in unacceptable finish quality or coverage since the material is not deposited as planned. Misalignment may lead to additional rework, such as additional (manual) sanding and/or touch-up.

Inaccurate spraying due to spray tip misalignment can cause inconsistencies between an expected output of material from the spraying end effector (e.g., based on a model of parameters and dynamics of the spraying end effector, robotic arm, and/or toolpaths therefore) and what output is actually detected by a perception system. Such inconsistencies can result in the inaccurate and/or inconsistent calibration of the perception system and/or the model. Moreover, because robotic systems such as robotic system 100 automates repetitive spraying tasks, such systems may repeatedly use substantially the same toolpaths to produce a consistent application of material from the spray tip. However, if the spray tip is misaligned and/or inconsistently biases the fan of material, the robotic systems may use the same toolpaths but erroneously produce a different application of material. Thus, misalignment of the tip can prevent such robotic systems from producing precise application of material.

### Exemplary Alignment Tools

The technical task of an alignment tool is to hold the spray tip in position when the spray tip is positioned to spray material. The alignment tool may have a plurality of operable positions. Operable positions may include an unlocked or disengaged operable position, a locked operable position, and an engaged operable position. The alignment tool is structurally designed to prevent the spray tip from being able to move in the pitch axis and/or the roll axis (e.g., as seen in FIG. 4). In some cases, the alignment tool may facilitate keeping the spray tip in a locked position (where the spray tip cannot spray material and is not in use).

In a first operable position, the alignment tool may be in an unlocked or disengaged operable position and is not operable to prevent movement of the spray tip. The alignment tool may make no contact with the spray tip, and the spray tip is free to rotate in the pitch axis and the roll axis.

In a second operable position, the alignment tool may be in a locked operable position and is operable to prevent some movement of the spray tip while the spray tip is in a locked position (e.g., not ready to spray material).

In a third operable position, the alignment tool may be in an engaged operable position and is operable to prevent movement of the spray tip while the spray tip is in an engaged position (e.g., ready to spray material). The alignment tool may make contact with a handle (or grip) of the spray tip, and the spray tip is prohibited by the alignment tool from rotating in the pitch axis and the roll axis.

The alignment tool may include an attachment member, which can be affixed to a manifold of the spraying end effector. The attachment member may include a first portion and a second portion. The first portion can have an outer track and an inner track. The second portion can be affixable to a manifold of a spraying end effector. In some cases, the attachment member may have a third portion that wraps around the spraying end effector.

The alignment tool may include a slider having a notch at one end of the slider. The slider can be movable along the outer track to be in at least: a first position where the notch is not engaged with a spray tip of the spraying end effector, and a second position where the notch is engaged to hold a flat end of the spray tip.

The alignment tool may include a stopping mechanism to hold the slider in position along the inner track. In some cases, a stopping mechanism includes a lever, which has a locking stud. The locking stud may interact with the inner track (e.g., locking stud may be rotated using the level) in a manner that locks the position of the locking stud in position within the inner track. In some cases, a stopping mechanism includes a ball nose spring plunger embedded in a handle of the slider and opposing detent surfaces in the attachment member (e.g., the inner track).

The outer track may be parallel to the inner track or allow movement along the same directions. The outer track may provide controlled movement along a first direction, and the inner track may provide detent or holding mechanisms to keep the slider in position.

Advantageously, the alignment tool is structured in such a way to maintain alignment of the spraying end effector relative to the distal end of a robotic arm. The alignment tool has an attachment member which is shaped and designed to be affixed snugly with the spraying end effector and is affixable to a manifold of the spraying end effector. The attachment mechanism to manifold can be relatively stable so that the alignment tool does not experience rotation in any direction. Additionally, the attachment mechanism may be shaped to fit with the spraying end effector, and as an assembly, the alignment tool and the spraying end effector do not rotate relative to each other in any direction. In some cases, the inner surfaces of a notch of the slider hold complementary flat surfaces of the spray tip (flat surfaces of the handle of the spray tip) to prevent the spray tip from rotating in the pitch axis. When the slider is in a locked position within the inner track, the slider is firmly pressed against and holds the spray tip in the notch, and the attachment member is firmly affixed to the manifold, the spray tip no longer can be rotated in the roll axis. The spray guard is thus held in place and prevented from rotating in the roll axis. Thus, the alignment tool simultaneously rigidly fixes the alignment of the spray tip in the pitch axis and the alignment of the spray guard in the roll axis to prevent misalignment of the combination of the spray tip and the spray guard, thereby creating a consistent, repeatable spray fan from the orifice of the spray tip desirable for robotic spray operations.

### Exemplary Alignment Tools With Lever

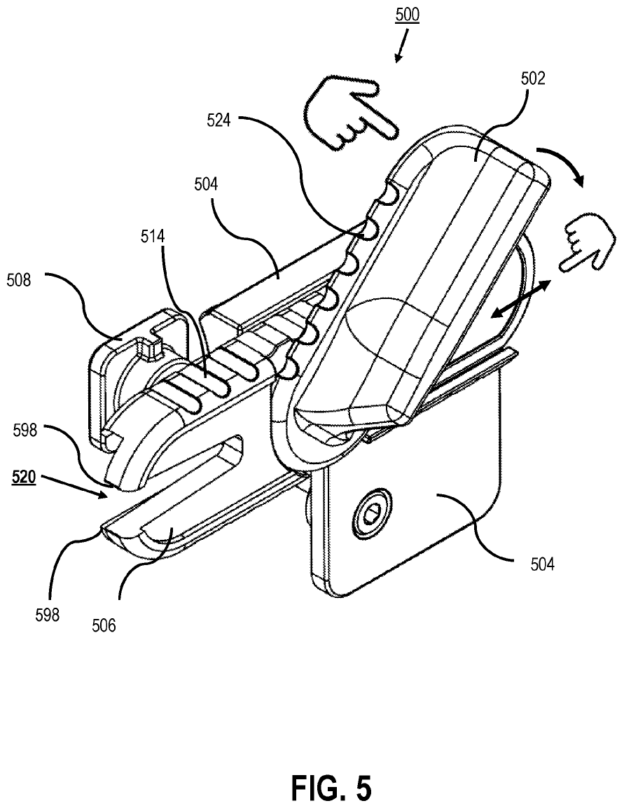

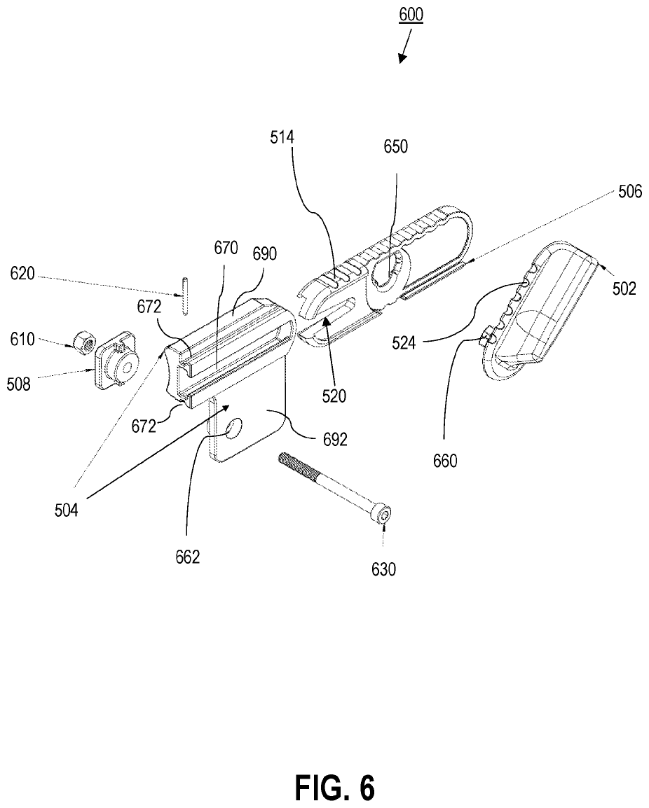

FIG. 5 is a perspective view 500 of an exemplary alignment tool, according to some aspects of the disclosed technology. FIG. 6 is an exploded view 600 of an exemplary alignment tool, according to some aspects of the disclosed technology. FIG. 7A-7C illustrate an arrangement 700 having an exemplary alignment tool illustrated in FIGS. 5 and 6 being used with an exemplary spraying end effector, according to some aspects of the disclosed technology. Slider 506 in FIG. 7A is in a first position (e.g., an unlocked or disengaged operable position). Slider 506 in FIGS. 7B-C is in a second position (e.g., an engaged operable position). The following passages make reference to FIGS. 5-7. While the alignment tool is shown with an exemplary spraying end effector, the spirit of the alignment tool is also applicable to other types of end effectors.

In some embodiments, the alignment tool can include an attachment member 504, a slider 506, and a lever 502. The alignment tool is used with an exemplary spraying end effector that includes spray gun 402, manifold 480, spray tip 408, and spray guard 406.

The attachment member 504 may be used to attach the alignment tool to the spraying end effector, preferably to a portion of the spraying end effector that is unlikely to be misaligned with (e.g., firmly affixed to) the distal end of the robotic arm. Indirectly through the attachment member 504, the alignment tool can ensure that other parts of the spraying end effector do not become misaligned relative to the distal end of the robotic arm.

The attachment member 504 can have a first portion 690, and a second portion 692. The first portion 690 can include an inner track 670. The first portion 690 can include one or more outer tracks 672. The slider 506 can mate with and slide along the one or more outer tracks 672.

A slider 506 may be in a first position where the slider 506 does not make physical contact with the spray tip 408. The first position of slider 506 is illustrated in FIG. 7A. The first position may be referred to as an unlocked or disengaged operable position of the alignment tool.

The one or more outer tracks 672 may be provided such that a slider 506 sliding in the direction of one or more outer tracks 672 can be used to apply a force along the direction of the one or more outer tracks 672 against a portion of the spray tip 408 (e.g., one or more surfaces of the spray tip 408) to help hold the spray tip 408 in position.

The slider 506 may transition from the first position to a second position by sliding or moving in the direction of the one or more outer tracks 672 towards the spray tip 408. The slider 506 may be in the second position where the slider 506, e.g., notch 520, makes physical contact with the spray tip 408, and applies the force along the direction of the inner track 670 to maintain alignment of the spray tip 408. The second position of slider 506 is illustrated in FIGS. 7A-7B. The second position may be referred to as an engaged operable position of the alignment tool.

The second portion 692 of the attachment member 504 may be affixable to a side of a manifold 480 of a spraying end effector. Since the manifold 480 of a spraying end effector can be firmly affixed to a distal end of a robotic arm, having the attachment member 504 affixable to the manifold 480 can ensure that both the attachment member 504 and the spraying end effector are more closely aligned with the distal end of the robotic arm.

If an end effector does not have a manifold such as manifold 480 (or attachment to a manifold is undesirable), the attachment member 504 may alternatively be attached a component of an end effector that is firmly affixed to a distal end of a robotic arm and is not expected to be misaligned relative to the distal end of the robotic arm.

In some cases, the attachment member 504 may be additionally or alternatively affixed to a distal end of the robotic arm directly.

In the example shown, the second portion 692 of the attachment member 504 can have an opening 662 for a fastener 630 (e.g., screw or bolt) to affix the attachment member 504 to at least one surface of the manifold 480. A corresponding retaining nut 508 and lock nut 610 may be provided on another end of the fastener 630 (and on another/opposite side of manifold 480). Fastener 630 can be placed through a borehole of manifold 480. The lock nut 610 is preferably tightened sufficiently to enable the retaining nut 508 to affix or attach the attachment member 504 to the spraying end effector firmly.

In some cases, the attachment member 504, e.g., the first portion 690 and/or the second portion 692 may have a surface that is shaped to match or be fitted against at least one surface of the spraying end effector (e.g., spray gun 402 and/or manifold 480), so that the attachment member 504 can hug the spraying end effector to further physically align the spraying end effector (e.g., such as the spray gun) tightly with the alignment tool.

In some cases, the first portion 690 and/or the second portion 692 of the attachment member 504 may have one or more surfaces that are shaped to match or be fitted against at least one surface of an end effector. With the one or more surfaces, the attachment member 504 can hug the end effector to further physically align the end effector tightly with the alignment tool and prevent misalignment of the alignment tool relative to the end effector.

The inner track 670 can be a C-shaped track. The inner track 670 can have a C-shaped cross section. Inner track 670 may be closed in a first end of the track, and the inner track 670 may be open in a second end of the track. A locking stud 660 is insertable into and is operable to slide within the inner track 670. To ensure the locking stud 660 does not slide out of the inner track 670, the second end of the track may include a spring slotted pin 620 that can be inserted into the inner track 670 after the locking stud 660 and slider 506 are assembled onto the track. The spring slotted pin 620 prevents the locking stud 660 from sliding off the inner track 670.

The slider 506 may have a notch 520 (e.g., lobster claw-shape, a V-shaped notch, a U-shaped notch, a W-shaped notch, a triangular notch, a rectangular notch, a trapezoidal notch) at one end of the slider. Notch 520 may have inner flat surfaces to complement flat surfaces of spray tip 408. Notch 520 may have pointed ends 598. The notch 520 may be shaped and/or sized to hold a flat end of a spray tip 408 (e.g., a flat finger-grip-able portion of spray tip 408, or handle 788 of spray tip 408) that is rotatable in a first axis (pitch axis), when slider 506 is in the second position as illustrated in FIGS. 7B-C. The slider 506 may have ridges 514 on at least one side of the slider 506 to allow a user to grip and move slider 506 more easily.

The slider 506 may further include an opening 650. The opening 650 of the slider may be sized and shaped to allow the locking stud 660 to be placed through the opening 650.

Lever 502 can include a locking stud 660 towards one end of the lever 502. The locking stud 660 is to mate with the inner track 670 through the opening 650 in the slider 506. Lever 502 may have ridges 524 on at least one side of the lever 502 to allow a user to grip and push or rotate lever 502 into a different position more easily. Lever 502 may include other elements to allow a user to grip or manipulate the position of lever 502.

As illustrated in FIG. 7A, lever 502 is in an unlocked position. As illustrated in FIG. 7B, lever 502 is in a locked position. As illustrated in FIG. 7C, lever 502 is in a transitional position.

Components of the alignment tool (other than the fastener 630, lock nut 610, and pin 620) can be fabricated using nylon or other suitable plastics. In some cases, the locking stud 660 may be formed from a metal material, and the attachment member 504 may be formed from suitable nylon, plastic, and/or resin materials.

### Exemplary Locking Stud of Lever

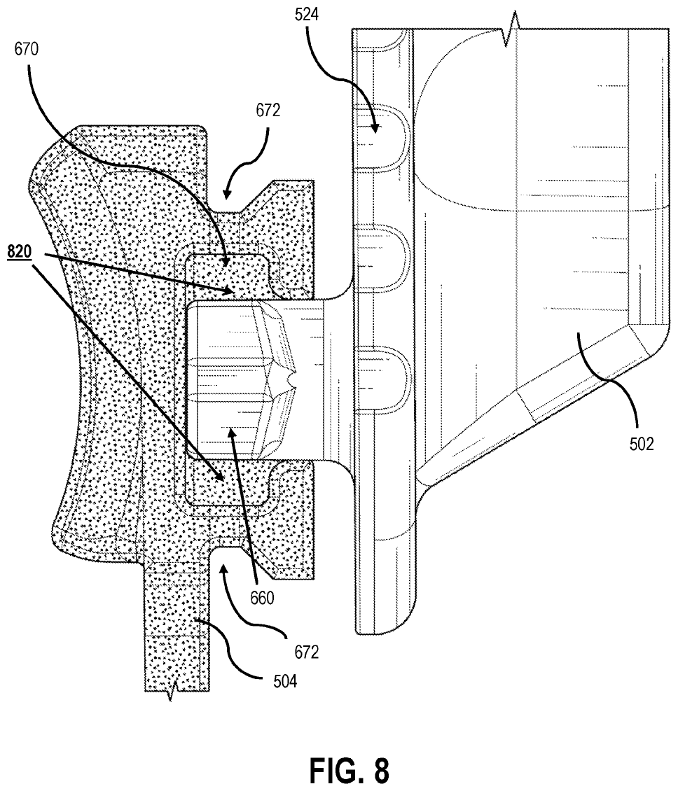

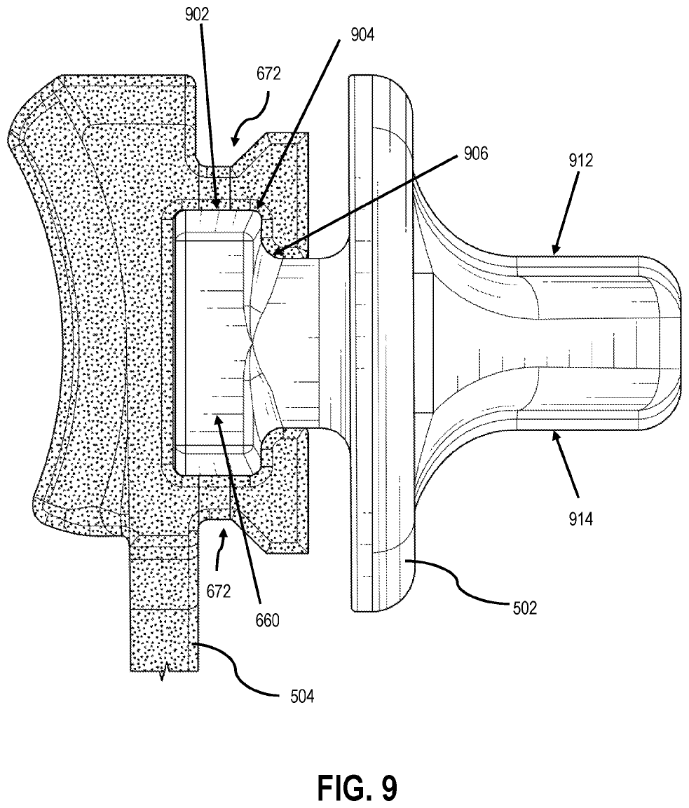

FIG. 8 illustrates lever 502 of the alignment tool in an unlocked position, according to some aspects of the disclosed technology. FIG. 9 illustrates a lever of the alignment tool in a locked position, according to some aspects of the disclosed technology. The slider 506 is not shown in FIG. 8 or FIG. 9 to better illustrate the interaction of a locking stud of the lever with a track of the attachment member. Although not shown in FIG. 8 or FIG. 9, a slider 506 may be positioned between (e.g., sandwiched between) the lever 502 and inner track 670 in the track.

Lever 502 has a first position (an unlocked position) that allows the slider 506 to slide through the inner track 670 and move in the direction of the inner track 670. The locking stud 660 may be shaped and sized in a first direction to allow the locking stud 660 to snugly fit through a lateral opening of the inner track 670. One length along the first direction of the locking stud 660 may match the height of the lateral opening of the inner track 670. Movement of the locking stud 660 is allowed due to the spacings 820 between the top and bottom inner surfaces of inner track 670. In the first position, the body of lever 502 may be aligned perpendicularly to a (sliding) direction of inner track 670.

Lever 502 may have a second position (a locked position) that disallows or prevents the slider 506 from sliding through, move, or change position, in the inner track 670 and from moving in the direction of the inner track 670. Lever 502 may be rotated to a locked position such that the body of the lever 502 is aligned parallel to the direction of inner track 670. In some cases, lever 502 is rotated or lowered to be aligned with a side of the attachment member 504. The locking stud 660 may be shaped and sized in a second direction perpendicular to the first direction to allow the locking stud 660 to snugly fit or pressure-fitted inside the inner track 670. Another length along the second direction may match the height of the inner cavity of the track. Substantially no spacing is allowed between the locking stud 660 and the top and bottom inner surfaces 902 of inner track 670. Additionally, the locking stud 660 may be shaped and sized to be slightly larger than the inner cavity of the track at contact points 904 and 906 so that the locking stud 660 is pressure-fitted within the inner cavity of the track to prevent locking stud 660 from moving within the inner track 670. The pressure-fit of the locking stud 660 within inner track 670 may apply pressure to or press the slider 506 towards the inner track 670. When the locking stud 660 of lever 502 is in the locked position, the locking stud 660 may fix a position of the slider 506 in the inner track 670, and/or prevents the slider from sliding in the track.

The lever 502 and attachment member 504 may be fabricated from materials that allow for the pressure-fitted arrangement to be reversible when a user lifts the lever 502 back into an unlocked position. In some cases, the locking stud 660 may be formed from a metal material, and the attachment member 504 may be formed from suitable nylon, plastic, and/or resin materials. Forming the locking stud 660 in a metal material can prevent excessive wear and tear of locking stud 660 from repeated rotations of the locking stud 660 within inner track 670. In some cases, the inner surfaces of inner track 670 may be formed from a metal material, and the locking stud 660 may be formed from suitable nylon, plastic, and/or resin materials. Forming the inner track 670 in a metal material can prevent excessive wear and tear of inner track 670 from repeated rotations of the locking stud 660 within inner track 670.

The lever 502 may have a shape that enables a user to manipulate and apply pressure to a surface of the lever 502 to push the lever 502 into the second position or push the lever out of the second position and back into the first position. Ridges 524 on one or more sides of lever 502 may provide grip for a user's fingers or hand to manipulate the lever 502. Surfaces 912 and 914 of lever 502 may provide areas for a user's fingers or hand to manipulate the lever 502 to change its position and/or apply pressure to the lever 502 (on surface 912 and/or surface 914). A user's fingers or palm may be used to apply pressure or force on surfaces 912 and/or 914 to change the lever 502's position between the first position and the second position.

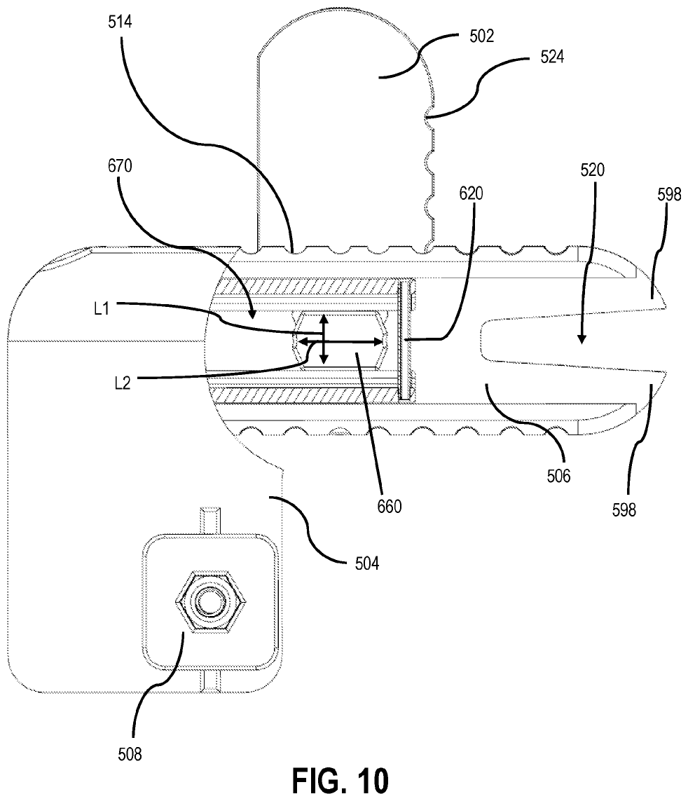

FIG. 10 illustrates a lever of an alignment tool in an unlocked position, according to some aspects of the disclosed technology. When lever 502 is in the unlocked position, the locking stud 660 is sized and shaped to not engage with the inner cavity or surfaces of inner track 670 (shown with hatching). The length of locking stud 660, labeled as L1, may be designed to not be larger than the opening of inner track 670.

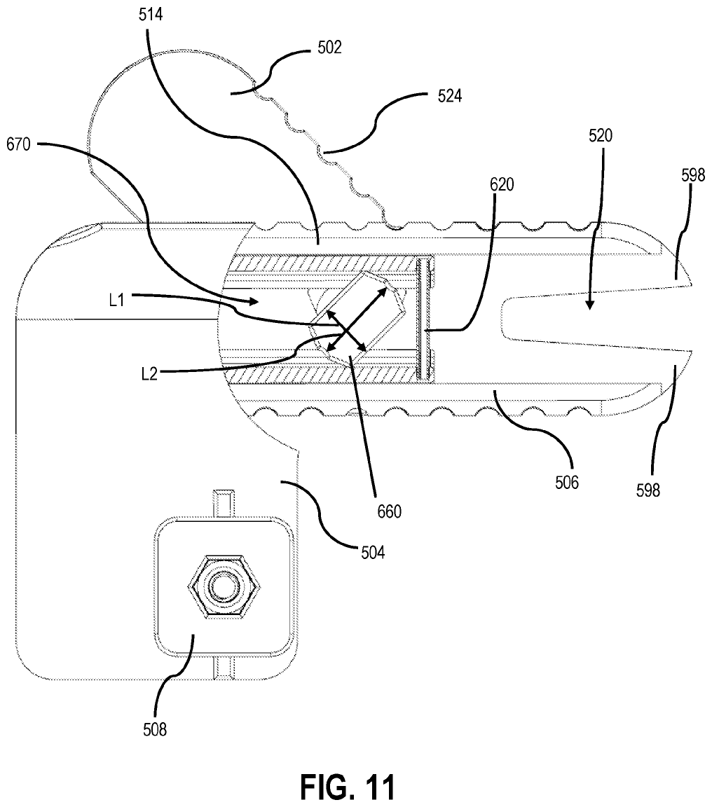

FIG. 11 illustrates a lever of the alignment tool in a transitional position, according to some aspects of the disclosed technology. When lever 502 and locking stud 660 rotate to a transitional position, the locking stud 660 may (begin to) engage with the inner cavity or surfaces of 670. The engagement with the inner surfaces of 670 may be disengaged with user-applied pressure to rotate lever 502.

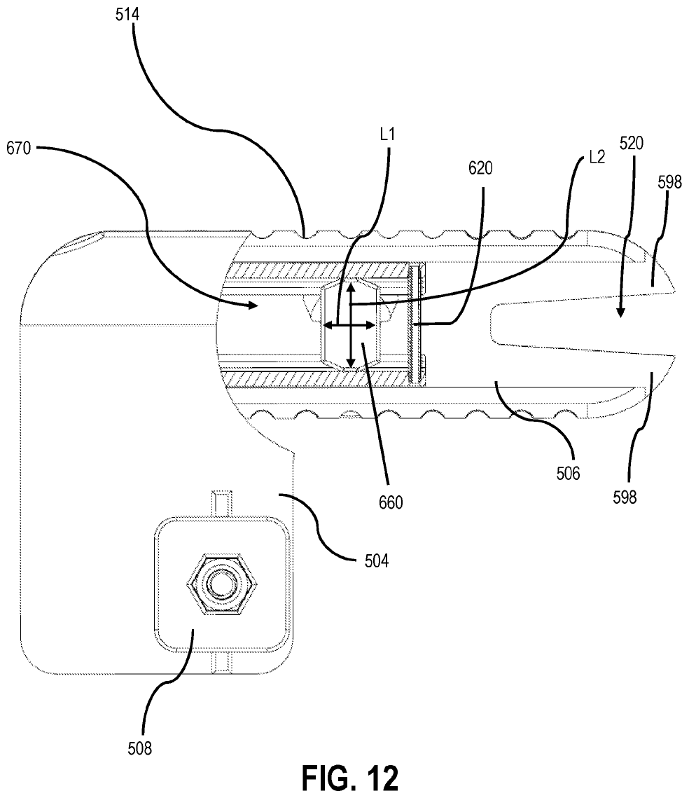

FIG. 12 illustrates a lever of the alignment tool in a locked position, according to some aspects of the disclosed technology. When lever 502 and locking stud 660 rotate to a locked position, the locking stud 660 is sized and shaped to engage with the inner cavity or surfaces of inner track 670. The length of locking stud 660, labeled as L2, may be designed to be larger than the opening of inner track 670, and the length may match a length of the inner cavity of 670. In the example shown, L2 is greater than L1. The locking stud 660 may be pressure-fitted with the inner cavity or surfaces of inner track 670 such that the lever 502 may not be easily rotated out of the locked position. Additionally, the pressure-fit of the locking stud 660 ensures the slider 506 (which is sandwiched between the inner track 670 and lever 502) is in a locked position and does not move or slide within inner track 670.

The engagement with the inner cavity or surfaces of inner track 670 in the locked position in FIG. 12 is greater than the engagement in the transitional position in FIG. 11. Greater user-applied pressure on lever 502 may be used to disengage the locking stud 660's engagement with the inner cavity or surfaces of inner track 670 in the locked position in FIG. 12, than the user-applied pressure on lever 502 to disengage the engagement with the inner cavity or surfaces of inner track 670 in the transitional position illustrated in FIG. 11.

The shape and size of locking stud 660 relative to a size of the inner cavity of inner track 670 can include elements that create a pressure-fit with points in the inner cavity of inner track 670 when locking stud 660 is in the locked position, but does not create a pressure-fit with those points in the inner cavity of inner track 670 when locking stud 660 is in the unlocked position or the transitional position.

Lever 502 and locking stud 660 may, in response to some user-applied pressure, transition between the unlocked position and the locked position, with the transitional position in between.

### Additional Variations of Alignment Tool

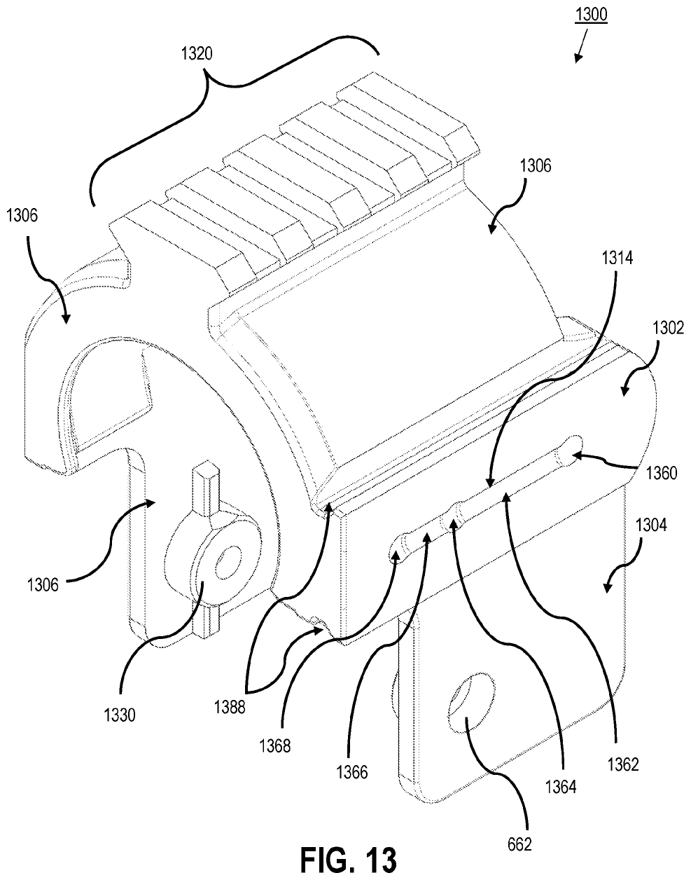

FIG. 13 is a perspective view of an exemplary wrap-around attachment member 1300, according to some aspects of the disclosed technology. Wrap-around attachment member 1300 may include similar portions and/or elements as the attachment member 504 in the FIGURES. Exemplary wrap-around attachment member 1300 may include a first portion 1302, a second portion 1304, and a third portion 1306. Third portion 1306 may more firmly affixes exemplary wrap-around attachment member 1300 to the spraying end effector and can offer more structural strength and/or support for the alignment tool to hold the spray tip in place.

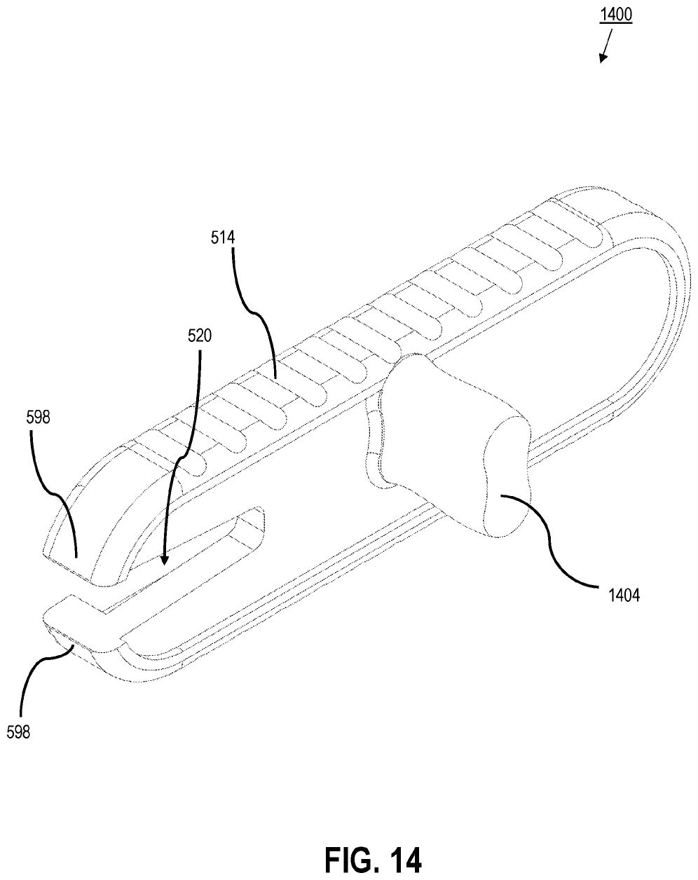

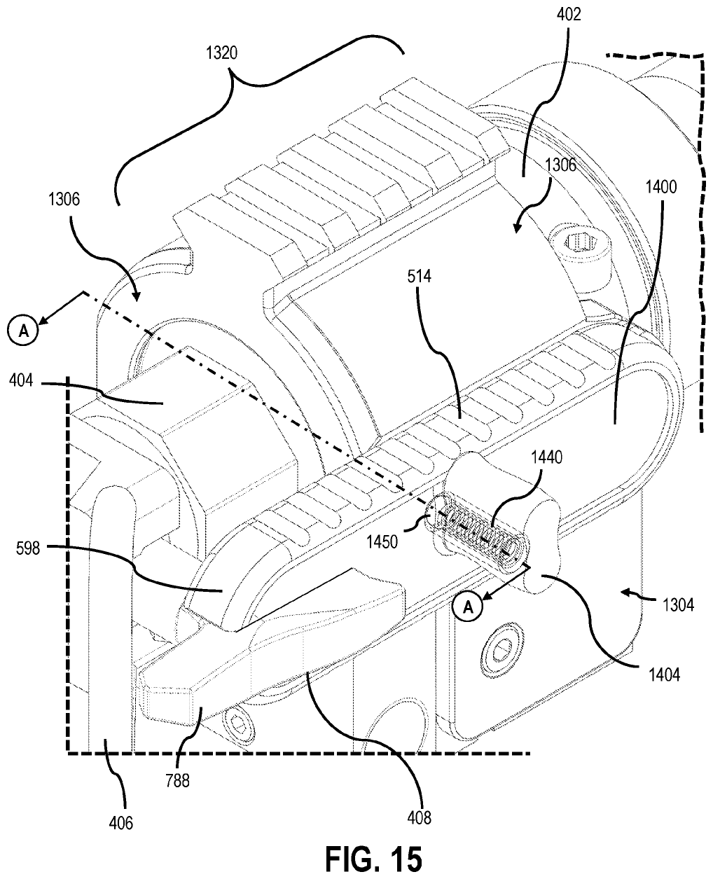

The first portion 1302 may include one or more outer tracks 1388 and an inner track 1314. The one or more outer tracks 1388 may be similar to the one or more outer tracks 672 in FIG. 6. A slider, such as the slider 1400 shown in FIG. 14 may be movable along the one or more outer tracks 1388 to be in at least in at least: a first position where the notch is not engaged with a spray tip of the spraying end effector, and a second position where the notch is engaged to hold a flat end of the spray tip. The inner track 1314 may be part of a stopping mechanism to stop movement of the slider. The inner track 1314 may interface with a ball nose spring plunger of a slider, such as the slider 1400 illustrated in FIGS. 15-23. Inner track 1314 may be formed on a surface of first portion 1302.

The second portion 1304 may be similar to the second portion 692 of FIG. 6.

The third portion 1306 wraps or contours around, e.g., a spraying end effector, from one side of the manifold to an opposite side of the manifold. The third portion 1306 can extend from the first portion 1302 to an opposite side of the manifold. The third portion 1306 can surround at least a portion of a spray gun of the spraying end effector when the attachment member 1300 is affixed to the manifold of a spraying end effector.

In some cases, the third portion 1306 may include a retaining shape 1330 opposite of opening 662 of the second portion 1304. A lock nut may be provided on another end of a fastener (and on another/opposite side of retaining shape 1330). The fastener can be placed through the opening 662, a borehole of a manifold through opening 662, and a hole in in retaining shape 1330. The lock nut can be tightened sufficiently to enable the retaining shape 1330 to maintain attachment member 504 to the spraying end effector firmly.

In some cases, the third portion 1306 may include a rail mount 1320 to allow for additional components to be attached to exemplary wrap-around attachment member 1300.

The inner track 1314 can include contours or surfaces that are designed to be a part of a stopping mechanism, to hold the position of a slider in place. Inner track 1314 may include different contact surfaces having different characteristics (e.g., shape, contour, depth, transitions) that can provide a detent or stopping mechanism or allow for smooth and controlled movement of a slider that may be movable along inner track 1314. Inner track 1314 may include a detent or stopping mechanism at various positions along inner track 1314 to allow the slider to be held in different positions along inner track 1314 (e.g., unlocked/disengaged, locked, and engaged operable positions).

Inner track 1314 may include a first contact surface 1360 to apply a first amount of force on a ball end of the ball nose spring plunger when the slider or alignment tool is in the first position (e.g., an unlocked or disengaged operable position). The first contact surface 1360 may be shaped to match the contour of the ball end of ball nose spring plunger so that the ball end may rest in the first contact surface 1360. Some amount of force may be needed or used to move the ball end away from the first contact surface 1360. The ball end may be in a substantially stable position when the ball end is pressed against the first contact surface 1360.

Inner track 1314 may include a second contact surface 1368 to apply the first amount of force on the ball end when the slider or alignment tool is in the second position (e.g., an engaged operable position). The second contact surface 1368 may be shaped to match the contour of the ball end of ball nose spring plunger so that the ball end may rest in the second contact surface 1368. Some amount of force may be needed to move the ball end away from the second contact surface 1368. The ball end may be in a substantially stable position when the ball end is pressed against the second contact surface 1368.

Inner track 1314 may include a third contact surface 1362 to apply a second amount of force on the ball end when the slider is moved away from the first position. The second amount of force being greater than the first amount of force. The second amount of force may push the ball end to depress the spring in the ball nose spring plunger, and the spring may apply a force against the third contact surface 1362. The third contact surface 1362 may be shaped like a track (e.g., gutter, channel, having a U-shaped cross sectional surface) to allow a ball end to smoothly roll or move along a length of the third contact surface 1362 with little force required.

Inner track 1314 may include a fourth contact surface 1366 to apply the second amount of force on the ball end when the slider is moved away from the second position. The second amount of force being greater than the first amount of force. The second amount of force may push the ball end to depress the spring in the ball nose spring plunger, and the spring may apply a force against the fourth contact surface 1366. The fourth contact surface 1366 may be shaped like a track e.g., gutter, channel, having a U-shaped cross sectional surface) to allow a ball end to smoothly roll or move along a length of the fourth contact surface 1366 with little force required.

In some cases, the slider is movable along the one or more outer tracks 1388 to be in a third position (e.g., a locked operable position) where pointed ends 598 of the notch 520 applies a normal force to the flat end of the spray tip (e.g., handle 788 of spray tip 408). The inner track 1314 may further include a fifth contact surface 1364 to apply the first amount of force on the ball end when the slider is in the third position. The fifth contact surface 1364 may be shaped to match the contour of the ball end of ball nose spring plunger so that the ball end may rest in the fifth contact surface 1364. Some amount of force may be needed to move the ball end away from the second contact surface 1368. The ball end may be in a substantially stable position when the ball end is pressed against the fifth contact surface 1364. The third position may be between the first position and the second position. The fifth contact surface 1364 may be positioned between the first contact surface 1360 and the second contact surface 1368.

In some embodiments, the inner track 1314 may include a series of contact surfaces, in this order: the first contact surface 1360, the third contact surface 1362, the fifth contact surface 1364, the fourth contact surface 1366, and the second contact surface 1368.

In some embodiments, the inner track 1314 may include a series of contact surfaces, in this order: the first contact surface 1360, the third contact surface 1362, the fourth contact surface 1366, and the second contact surface 1368. The fifth contact surface 1364 may be omitted.

As depicted in FIG. 13, the first portion 1302 has an inner track 1314 that differs from the inner track 670 in FIG. 6. It is envisioned that, in some embodiments, the inner track 1314 may be replaced by inner track 670 for wrap-around attachment member 1300 to interface with a locking stud 660 in FIG. 6 instead.

FIG. 14 is a perspective view of an exemplary slider 1400 having a handle 1404, according to some aspects of the disclosed technology. Slider 1400 may include similar elements as slider 506 of FIG. 5. For example, slider 1400 may include notch 520. Slider 1400 may include pointed ends 598 of notch 520. Slider 1400 may include one or more ridges 514. Notable differences between slider 1400 from slider 506 is that slider 1400 does not have an opening and does not need to operate with a lever. Slider 1400 has an integrated handle 1404 that allows a user to move the slider 1400 along the direction of the one or more outer tracks of the attachment member. The stopping mechanism implemented with slider 1400 differs from the stopping mechanism implemented with slider 506 and lever 502. The alignment functionality of notch 520 is the same.

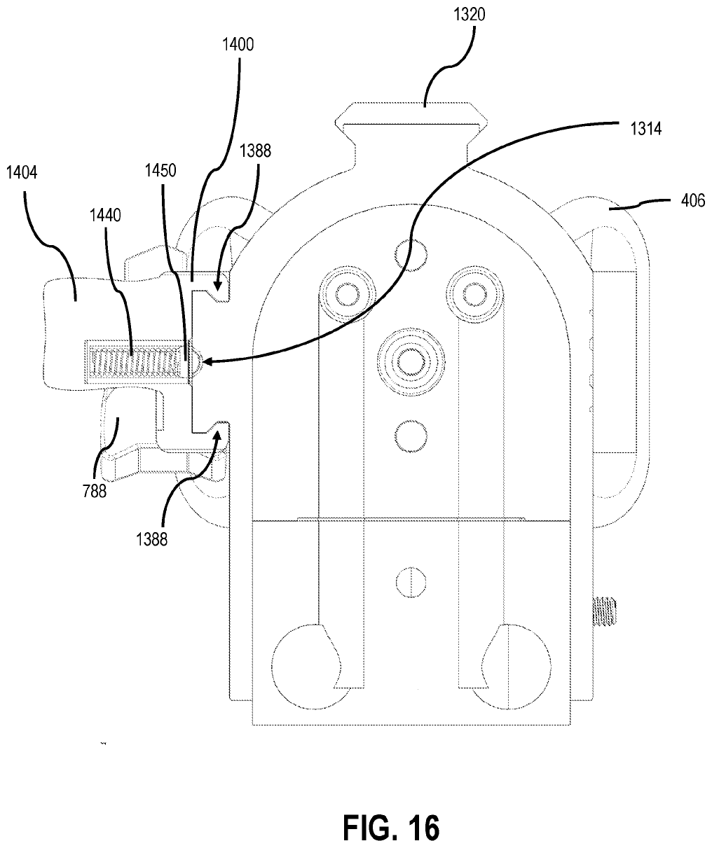

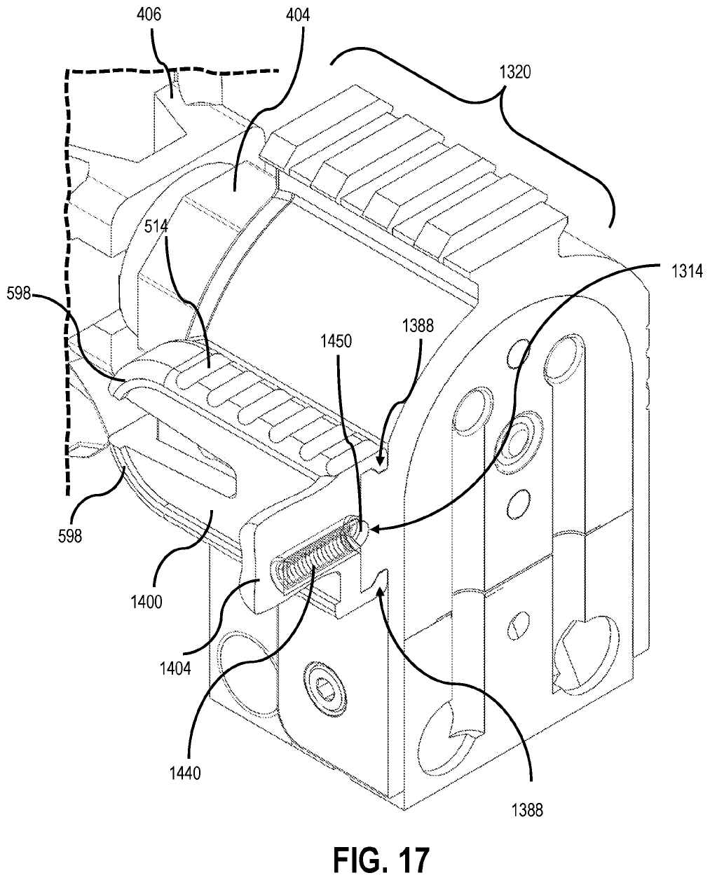

FIG. 15 is a perspective view of an alignment tool having slider 1400 being used with an exemplary spraying end effector, depicting a ball end spring plunger 1440 embedded in the slider 1400, according to some aspects of the disclosed technology. FIG. 16 is a cross section view of the alignment tool of FIG. 15 at line A, according to some aspects of the disclosed technology. FIG. 17 is a perspective cut view of the alignment tool of FIG. 15 cut at line A, according to some aspects of the disclosed technology.

In the illustrated alignment tool of FIGS. 15-17, the stopping mechanism may include a ball nose spring plunger 1440 fitted in an opening and/or cavity formed in the handle 1404. The ball nose spring plunger 1440 may include a ball end 1450. Ball end 1450 may interface with the inner track 1314 of exemplary wrap-around attachment member 1300.

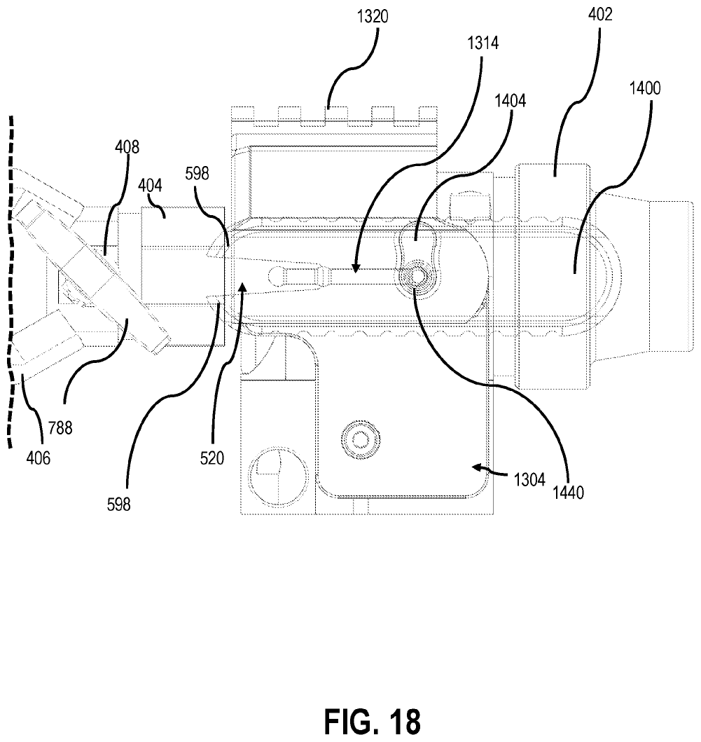

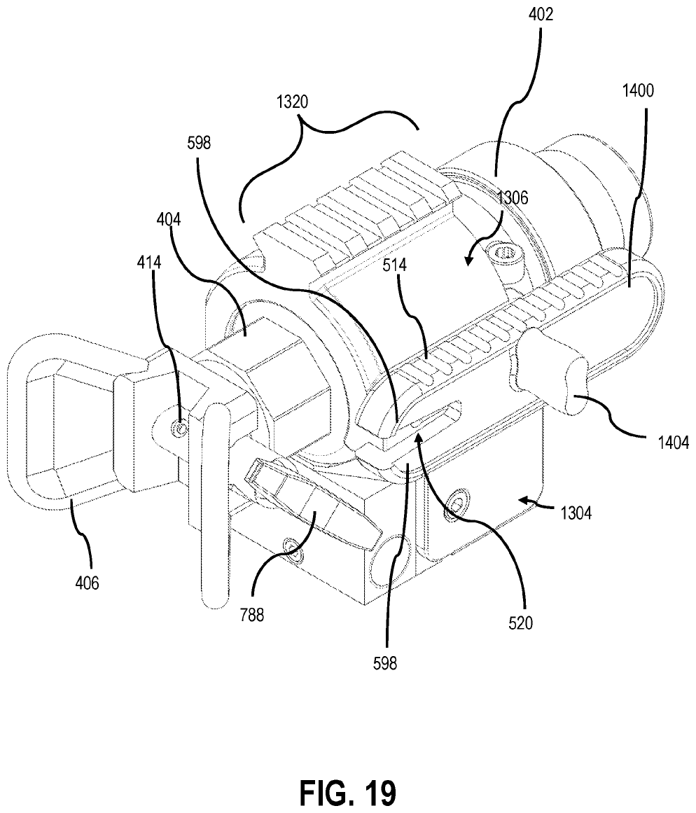

FIG. 18 depicts a side view of an exemplary alignment tool being used with an exemplary spraying end effector, the exemplary alignment tool having a slider in a first position, according to some aspects of the disclosed technology. FIG. 19 depicts a perspective view of the exemplary alignment tool of FIG. 18 having the slider in the first position, according to some aspects of the disclosed technology. The first position may be the unlocked and/or disengaged operable position of the alignment tool. Slider 1400 may remain in place by virtue of ball end 1450 interfacing with surfaces of inner track 1314. Pointed ends 598 do not contact the spray tip 408 or handle 788. Spray tip 408 is free to rotate or can be removed from the spraying end effector. Slider 1400 is out of the way and is disengaged.

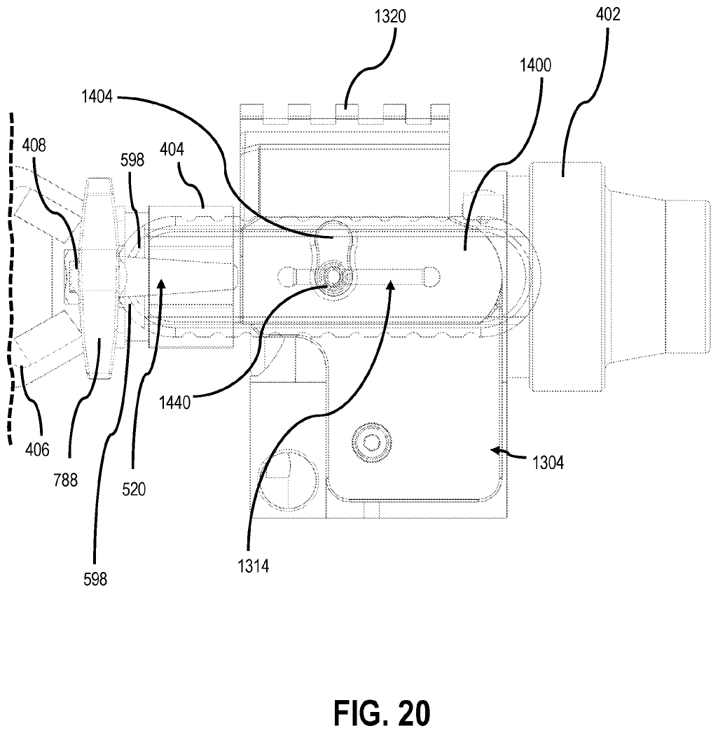

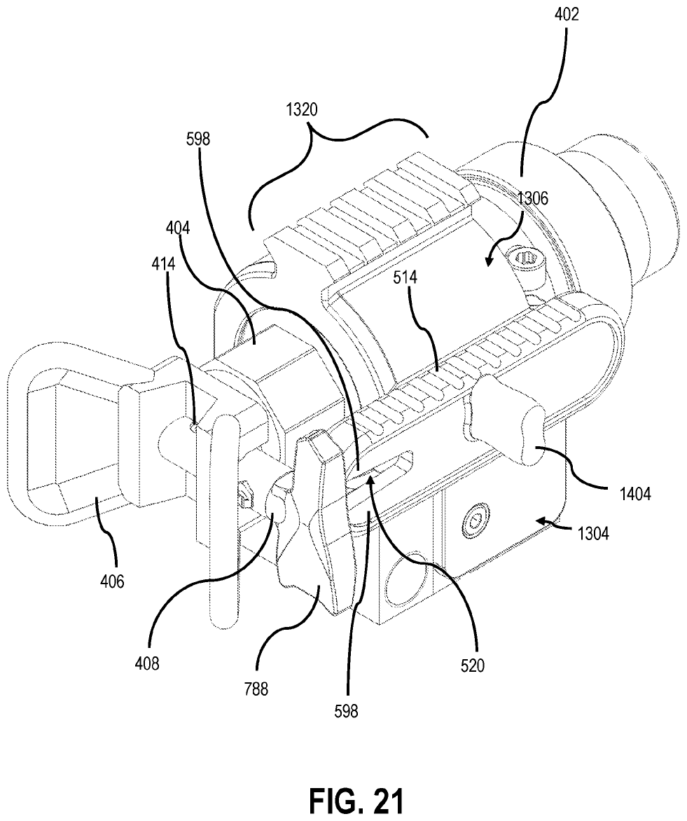

FIG. 20 depicts a side view of the exemplary alignment tool of FIG. 18, the exemplary alignment tool having the slider in a second position, according to some aspects of the disclosed technology. FIG. 21 depicts a perspective view of the exemplary alignment tool of FIG. 18 having the slider in the second position, according to some aspects of the disclosed technology. The second position may be the locked operable position of the alignment tool. Slider 1400 may remain in place by virtue of ball end 1450 interfacing with surfaces of inner track 1314. As illustrated, a user may push handle 1404 of the slider 1400 in a suitable direction to change the position of slider 1400 along the inner track 1314. While the slider is in an unlocked and/or disengaged operable position of the alignment tool (e.g., first position as illustrated in FIGS. 18-19), a user may rotate spray tip 408 into a locked position. Then, the user may change the position of slider 1400 along the inner track 1314 (e.g., by pushing handle 1404 in a suitable direction) to the locked operable position. In the locked operable position, pointed ends 598 may abut a flat surface of handle 788 to keep spray tip 408 in a locked position. Pointed ends 598 may apply a normal force to the flat surface of handle 788.

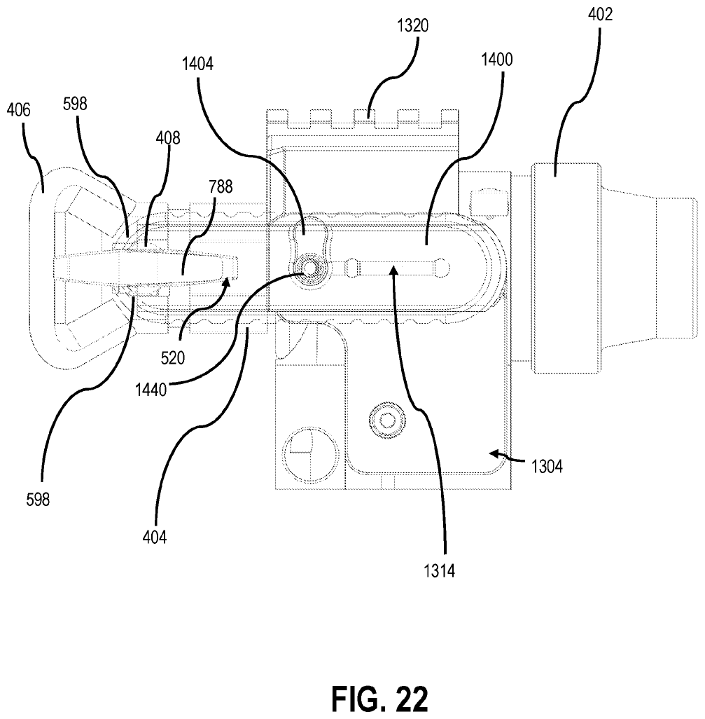

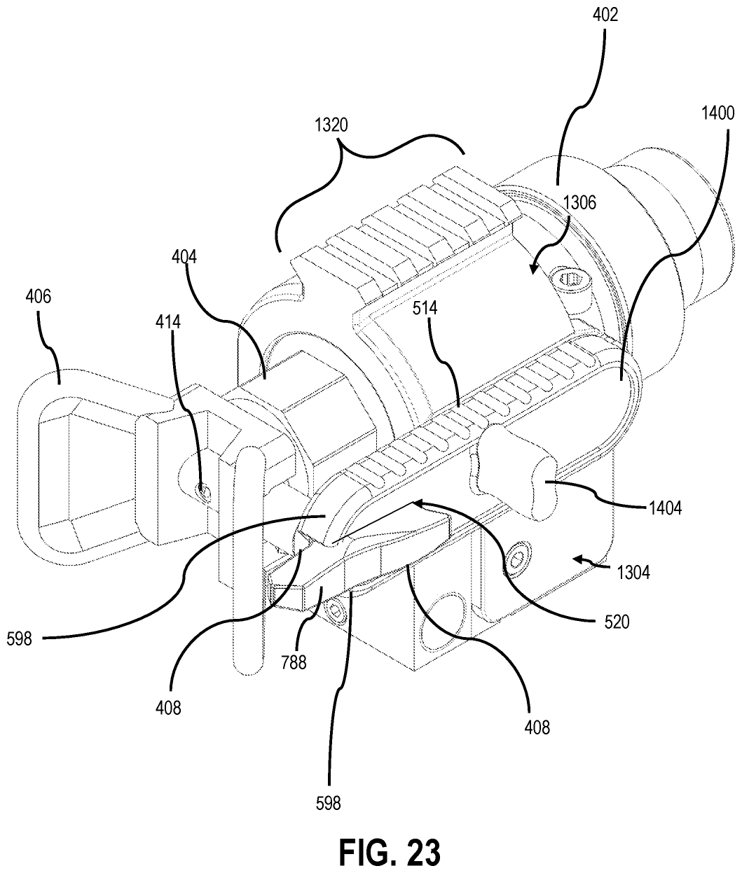

FIG. 22 depicts a side view of the exemplary alignment tool of FIG. 18, the exemplary alignment tool having the slider in a third position, according to some aspects of the disclosed technology. FIG. 23 depicts a perspective view of the exemplary alignment tool of FIG. 18 having the slider in the third position, according to some aspects of the disclosed technology. The third position may be the engaged operable position of the alignment tool. Slider 1400 may remain in place by virtue of ball end 1450 interfacing with surfaces of inner track 1314. As illustrated, a user may push handle 1404 of the slider 1400 in a suitable direction to change the position of slider 1400 along the inner track 1314. While the slider is in an unlocked and/or disengaged operable position of the alignment tool (e.g., first position as illustrated in FIGS. 18-19), a user may rotate spray tip 408 into an engaged position (with the orifice 414 pointing forward). Then, the user may change the position of slider 1400 along the inner track 1314 (e.g., by pushing handle 1404 in a suitable direction) to the engaged operable position. In the engaged operable position, notch 520 of slider 1400 engages with the flat surfaces of handle 788 to hold spray tip 408 in place.

### Select Examples

Example 1 provides an alignment tool including an attachment member having a first portion and a second portion, where the first portion has an outer track and an inner track, and the second portion is affixable to a side of a manifold of a spraying end effector; a slider having a notch at one end of the slider, where the slider is movable along the outer track to be in at least: a first position where the notch is not engaged with a spray tip of the spraying end effector, and a second position where the notch is engaged to hold a flat end of the spray tip; and a stopping mechanism to hold the slider in position along the inner track.

Example 2 provides the alignment tool of example 1, where the attachment member has a surface that is fitted with at least one surface of the spraying end effector.

Example 3 provides the alignment tool of example 1 or 2, where: the attachment member has a third portion; and the third portion extends from the first portion to an opposite side of the manifold.

Example 4 provides the alignment tool of any one of examples 1-3, where the second portion has an opening for a fastener to affix the attachment member to at least one surface of the manifold.

Example 5 provides the alignment tool of any one of examples 1-4, where the second portion is shaped to fit with at least one surface of the manifold.

Example 6 provides the alignment tool of any one of examples 1-5, where the manifold is affixed to a distal end of a robotic arm.

Example 7 provides the alignment tool of any one of examples 1-6, where the slider has ridges on one side.

Example 8 provides the alignment tool of any one of examples 1-7, where the notch is sized to hold a flat end of the spray tip.

Example 9 provides the alignment tool of any one of examples 1-8, where: the spray tip is rotatable in a first axis; the spray tip is inserted in a spray guard of the spraying end effector; and the spray guard is rotatable in a second axis.

Example 10 provides the alignment tool of example 9, where: the spray tip has an orifice pointing perpendicularly from a long axis of a cylindrical portion of the spray tip, and the orifice is to release material in a fan.

Example 11 provides the alignment tool of any one of examples 1-10, where: the stopping mechanism includes a lever; the lever has a locking stud towards one end of the lever; and the locking stud is to mate with the inner track through an opening in the slider.

Example 12 provides the alignment tool of example 11, where the opening of the slider is sized to allow the locking stud to be placed through the opening.

Example 13 provides the alignment tool of example 11 or 12, where the lever has a first position that allows the slider to slide through the inner track, and a second position that pressure fits the locking stud in the inner track.

Example 14 provides the alignment tool of example 13, where the lever in the second position fixes a position of the slider in the inner track.

Example 15 provides the alignment tool of example 13 or 14, where the lever in the second position prevents the slider from sliding in the inner track.

Example 16 provides the alignment tool of any one of examples 11-15, where the lever has ridges on one side.

Example 17 provides the alignment tool of any one of examples 11-15, where the inner track has a C-shaped cross section.

Example 18 provides the alignment tool of any one of examples 11-17, where: the inner track is closed in a first end of the inner track, and the inner track is open in a second end of the inner track.

Example 19 provides the alignment tool of example 18, where the second end of the inner track further includes a spring slotted pin.

Example 20 provides the alignment tool of any one of examples 1-10,where: the slider has a handle; and the stopping mechanism includes a ball nose spring plunger fitted in an opening formed in the handle.

Example 21 provides the alignment tool of example 20, where the inner track includes a first contact surface to apply a first amount of force on a ball end of the ball nose spring plunger when the slider is in the first position; a second contact surface to apply the first amount of force on the ball end when the slider is in the second position; a third contact surface to apply a second amount of force on the ball end when the slider is moved away from the first position, the second amount of force being greater than the first amount of force; and a fourth contact surface to apply the second amount of force on the ball end when the slider is moved away from the second position.

Example 22 provides the alignment tool of example 21, where: the slider is movable along the outer track to be in a third position where pointed ends of the notch applies a normal force to the flat end of the spray tip; and the inner track further includes a fifth contact surface to apply the first amount of force on the ball end when the slider is in the third position.

Example 23 provides the alignment tool of example 22, where the third position is between the first position and the second position.

Example 24 provides a robotic system, including a base unit; a positioning system having a first end and a second end, where the positioning system is affixed to the base unit at the first end, and the positioning system is to change position of the second end; a spraying end effector affixed to the second end of the positioning system, the spraying end effector having a manifold affixed to the second end of the positioning system, a spray tip having an orifice to release material rotatable in a pitch direction, and a spray guard rotatable in a roll direction; and an alignment tool according to any one of examples 1-23.

Example 25 provides the robotic system of example 24, where the spraying end effector sprays bands of material on selected structural components of a building structure.

Example 26 provides the robotic system of example 24 or 25, further including a perception system to determine one or more locations of structural components of a building structure.

### Variations and Other Notes

The detailed description, such as the “Select examples” section, provide various examples of the embodiments disclosed herein.

The detailed description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the detailed description.

For purposes of explanation, specific numbers, materials and configurations are set forth in order to provide a thorough understanding of the illustrative implementations. However, it will be apparent to one skilled in the art that the present disclosure may be practiced without the specific details and/or that the present disclosure may be practiced with only some of the described aspects. In other instances, well known features are omitted or simplified in order not to obscure the illustrative implementations.

Further, references are made to the accompanying drawings that form a part hereof, and in which are shown, by way of illustration, embodiments that may be practiced. It is to be understood that other embodiments may be utilized, and structural or logical changes may be made without departing from the scope of the present disclosure. Therefore, the detailed description is not to be taken in a limiting sense.

Various operations may be described as multiple discrete actions or operations in turn, in a manner that is most helpful in understanding the disclosed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, or device, that comprises a list of elements is not necessarily limited to only those elements but may include other elements not expressly listed or inherent to such method, process, or device. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description and the accompanying drawings.

1. An alignment tool comprising:
an attachment member having a first portion and a second portion, wherein the first portion has an outer track and an inner track, and the second portion is affixable to a side of a manifold of a spraying end effector;
a slider having a notch at one end of the slider, wherein the slider is movable along the outer track to be in at least: a first position where the notch is not engaged with a spray tip of the spraying end effector, and a second position where the notch is engaged to hold a flat end of the spray tip; and
a stopping mechanism to hold the slider in position along the inner track.

2. The alignment tool of claim 1, wherein the attachment member has a surface that is fitted with at least one surface of the spraying end effector.

3. The alignment tool of claim 1, wherein:
the attachment member has a third portion; and
the third portion extends from the first portion to an opposite side of the manifold.

4. The alignment tool of claim 1, wherein the second portion has an opening for a fastener to affix the attachment member to at least one surface of the manifold.

5. The alignment tool of claim 1, wherein the second portion is shaped to fit with at least one surface of the manifold.

6. The alignment tool of claim 1, wherein the manifold is affixed to a distal end of a robotic arm.

7. The alignment tool of claim 1, wherein the slider has ridges on one side.

8. The alignment tool of claim 1, wherein the notch is sized to hold a flat end of the spray tip.

9. The alignment tool of claim 1, wherein:
the spray tip is rotatable in a first axis;
the spray tip is inserted in a spray guard of the spraying end effector; and
the spray guard is rotatable in a second axis.

10. The alignment tool of claim 9, wherein:
the spray tip has an orifice pointing perpendicularly from a long axis of a cylindrical portion of the spray tip, and
the orifice is to release material in a fan.

11. The alignment tool of claim 1, wherein:
the stopping mechanism comprises a lever;
the lever has a locking stud towards one end of the lever; and
the locking stud is to mate with the inner track through an opening in the slider.

12. (canceled)

13. (canceled)

14. (canceled)

15. (canceled)

16. (canceled)

17. (canceled)

18. The alignment tool of claim 11, wherein:
the inner track is closed in a first end of the inner track, and
the inner track is open in a second end of the inner track.

19. The alignment tool of claim 18, wherein the second end of the inner track further includes a spring slotted pin.

20. An alignment tool comprising:
an attachment member having a first portion and a second portion, wherein the first portion has an outer track and an inner track, and the second portion is affixable to a side of a manifold of a spraying end effector;
a slider having a notch at one end of the slider and a handle, wherein the slider is movable along the outer track to be in at least: a first position where the notch is not engaged with a spray tip of the spraying end effector, and a second position where the notch is engaged to hold a flat end of the spray tip; and
a stopping mechanism comprising a ball nose spring plunger fitted in an opening formed in the handle to hold the slider in position along the inner track.

21. The alignment tool of claim 20, wherein the inner track comprises:
a first contact surface to apply a first amount of force on a ball end of the ball nose spring plunger when the slider is in the first position;
a second contact surface to apply the first amount of force on the ball end when the slider is in the second position;
a third contact surface to apply a second amount of force on the ball end when the slider is moved away from the first position, the second amount of force being greater than the first amount of force; and
a fourth contact surface to apply the second amount of force on the ball end when the slider is moved away from the second position.

22. The alignment tool of claim 21, wherein:
the slider is movable along the outer track to be in a third position where pointed ends of the notch applies a normal force to the flat end of the spray tip; and
the inner track further comprises a fifth contact surface to apply the first amount of force on the ball end when the slider is in the third position.

23. The alignment tool of claim 22, wherein the third position is between the first position and the second position.

24. A robotic system, comprising:
a base unit;
a positioning system having a first end and a second end, wherein the positioning system is affixed to the base unit at the first end, and the positioning system is to change position of the second end;
a spraying end effector affixed to the second end of the positioning system, the spraying end effector having a manifold affixed to the second end of the positioning system, a spray tip having an orifice to release material rotatable in a pitch direction, and a spray guard rotatable in a roll direction; and
an alignment tool comprising:
an attachment member having a first portion and a second portion, wherein the first portion has an outer track and an inner track, and the second portion is affixable to a side of a manifold of the spraying end effector;
a slider having a notch at one end of the slider, wherein the slider is movable along the outer track to be in at least: a first position where the notch is not engaged with a spray tip of the spraying end effector, and a second position where the notch is engaged to hold a flat end of the spray tip; and
a stopping mechanism to hold the slider in position along the inner track.

25. The robotic system of claim 24, wherein the spraying end effector sprays bands of material on selected structural components of a building structure.

26. The robotic system of claim 24, further comprising:
a perception system to determine one or more locations of structural components of a building structure.
